(19) United States
(12) Patent Application Publication
(10) Pub. No.: US 2026/0070822 A1
(43) Pub. Date: Mar. 12, 2026

(54) PLASMA PLATFORM FOR RAPID DEGRADATION OF TOXIC ORGANIC COMPOUNDS INCLUDING PER- AND POLYFLUORINATED COMPOUNDS

(71) Applicants: Thomas M. Holsen, Potsdam, NY (US); Selma Mededovic, Potsdam, NY (US)

(72) Inventors: Thomas M. Holsen, Potsdam, NY (US); Selma Mededovic, Potsdam, NY (US)

(73) Assignee: Clarkson University, Potsdam, NY (US)

(21) Appl. No.: 19/326,235

(22) Filed: Sep. 11, 2025

Related U.S. Application Data
(60) Provisional application No. 63/693,572, filed on Sep. 11, 2024.
(60) Provisional application No. 63/867,324, filed on Aug. 20, 2025.

(51) Int. Cl. C02F 1/78; C02F 1/72; C02F 101/36

(52) U.S. Cl. CPC C02F 1/78; C02F 1/722; C02F 2101/36; C02F 2201/32; C02F 2201/46135; C02F 2305/023; C02F 2305/026; C02F 2305/04

(57) ABSTRACT

The present disclosure relates to water treatment systems utilizing non-thermal plasma processes integrated with advanced oxidation processes for the rapid degradation and removal of per-and polyfluorinated compounds (PFAS) and other toxic organic contaminants. This approach addresses the chemical stability and mass-transfer limitations of toxic organic compounds including PFAS by generating reactive species at the gas-liquid interface and employing oxidative radicals in the bulk liquid. The solution enables thorough defluorination and minimizes harmful byproducts, with optional surfactant addition and gas injection to enhance transport and reaction efficiency. Principal uses include scalable and energy-efficient remediation of toxic organic compounds contaminated water in municipal, industrial, and environmental applications.

### CROSS REFERENCE TO RELATED APPLICATION

The present application relates and claims priority to U.S. Provisional Application Nos. 63/693,572 filed Sep. 11, 2024, and 63/867,324 filed Aug. 20, 2025, the entirety of each of which is hereby incorporated by reference.

### FIELD OF INVENTION

The present disclosure relates generally to water treatment systems, and more specifically to systems utilizing plasma-based processes combined with advanced oxidation processes (AOPs) for the degradation and removal of toxic organic compounds including per-and polyfluorinated compounds (PFAS) and other toxic organic contaminants.

### BACKGROUND

A per- and polyfluoroalkyl substance (PFAS) is a class of synthetic organic compounds characterized by robust carbon-fluorine bonds that provide resistance to heat, chemical attack, and biodegradation. Extensively utilized in industrial processes and consumer products—such as firefighting foams, nonstick cookware coatings, and stain repellents—PFAS have become widespread environmental contaminants. Their persistence and mobility in aqueous systems pose notable risks to human health and ecological receptors, leading to stringent regulatory limits and increasing public concern. PFAS contamination in drinking water supplies represents a significant obstacle to maintaining water quality and safeguarding the environment.

Prior research on PFAS remediation has focused on conventional water treatment technologies, including adsorption onto activated carbon, ion-exchange resins, membrane separations, and various advanced oxidation processes. These methods often require substantial energy input or frequent sorbent regeneration, generate secondary waste streams, and may fail to achieve complete mineralization of target compounds. In particular, oxidative treatments that rely primarily on hydroxyl radicals can exhibit limited efficacy against long-chain PFAS, leaving persistent intermediates and fluoride-containing byproducts in the treated effluent.

Different approaches have been pursued to address the limitations of single-technique PFAS removal. These include the application of gas-phase electrical discharge plasma systems at the gas-liquid interface, advanced oxidation processes—such as Fenton's reaction (including heterogeneous and photo-Fenton embodiments), UV/H₂O₂, activated persulfate, and UV/TiO₂ photolysis—and mass-transfer enhancement strategies like surfactant addition, foam fractionation, and bubble hydrodynamic adjustments. However, each of these strategies, when implemented in isolation, often results in incomplete defluorination, accumulation of intermediates, or complex operational demands that limit scalability and cost-effectiveness.

The operation of plasma reactors for PFAS degradation involves generation of reactive species—atomic oxygen (O·), hydrogen radicals (H·), ozone (O₃), hydrogen peroxide (H₂O₂), hydrated electrons (eₐq⁻) , and ionized carrier gas species—predominantly at the gas-liquid interface. In contrast, advanced oxidation processes generate hydroxyl or sulfate radicals in the bulk liquid phase. As a result, mass-transfer constraints can leave a portion of the PFAS load unexposed to high-energy radicals, while the transient nature of these oxidative species and the logistical challenges of chemical dosing hinder complete defluorination.

Integrative approaches that combine physical separation techniques with individual oxidation or plasma treatments have demonstrated incremental improvements in PFAS degradation rates and fluoride yields. For example, coupling foam fractionation with plasma discharge can enhance pollutant contact with reactive zones, and integrating membrane pre-treatment with Fenton-based oxidation can reduce intermediate formation. However, these multi-step processes generally involve complex instrumentation, extensive operational control, and elevated energy or chemical demands.

Accordingly, there is a need in the art for an integrated water treatment approach that overcomes both the chemical stability of toxic organic compounds including PFAS compounds and the mass-transfer limitations of existing technologies, enabling rapid, complete degradation and high fluoride yields without excessive energy consumption or secondary waste generation.

### SUMMARY OF THE INVENTION

The present disclosure relates to a plasma platform for rapid degradation of toxic organic compounds including per-and polyfluorinated compounds in water treatment systems. The described system integrates non-thermal plasma processes with advanced oxidation processes to enhance the removal and breakdown of toxic organic compounds including per- and polyfluorinated compounds (PFAS) and other toxic organic contaminants.

The described technology provides a method for treating a liquid containing per- and polyfluorinated compounds by contacting the liquid with non-thermal plasma generated at a gas-liquid interface in an enhanced-contact electrical discharge plasma reactor, producing reactive species within the system, further treating the liquid with an advanced oxidation process to generate additional oxidative radicals, optionally introducing a surfactant to promote transport of PFAS to the gas-liquid interface, and optionally injecting a gas stream to facilitate bubble formation and foam fractionation.

The advanced oxidation process may include Fenton's reaction, UV/H₂O₂ treatment, activated persulfate oxidation, or UV irradiation in the presence of titanium dioxide. Hydrogen peroxide for the advanced oxidation process can be produced in situ by the non-thermal plasma. The surfactant may be dodecyltrimethylammonium bromide, and the gas stream may comprise argon. The non-thermal plasma may be generated by applying a pulsed voltage of between −20 kV and −40 kV to the electrodes. Reactive species produced in situ include atomic oxygen, hydrogen radicals, ozone, and hydrogen peroxide. Foam fractionation may be employed to transport PFAS-enriched foam to the liquid surface, and the liquid may comprise an aqueous solution.

The described technology further provides a system for treating a liquid containing per-and polyfluorinated compounds. This system comprises an electrical discharge plasma reactor designed to generate non-thermal plasma at a gas-liquid interface and produce reactive species within the liquid, an advanced oxidation process unit operatively associated with the plasma reactor and designed to generate additional oxidative radicals in the liquid, a surfactant introduction mechanism configured to optionally introduce a surfactant into the liquid to enhance transport of per-and polyfluorinated compounds to the gas-liquid interface, and a gas injection mechanism configured to optionally supply a gas stream to facilitate bubble formation and foam fractionation in the liquid.

The advanced oxidation process unit may comprise a Fenton's reaction unit including heterogeneous Fenton and photo-Fenton, a UV/H₂O₂ treatment unit, an activated persulfate oxidation unit, or a UV irradiation unit in the presence of titanium dioxide. The electrical discharge plasma reactor may be configured to produce hydrogen peroxide in situ for use by the advanced oxidation process unit. The surfactant introduction mechanism may introduce dodecyltrimethylammonium bromide into the liquid, and the gas injection mechanism may supply an argon gas stream and facilitate foam fractionation to recover PFAS-enriched foam from the liquid surface. The electrical discharge plasma reactor may apply a pulsed voltage of between −20 kV and −40 kV to the electrodes, and reactive species produced may include atomic oxygen, hydrogen radicals, ozone, and hydrogen peroxide. The liquid treated may comprise an aqueous solution.

### BRIEF DESCRIPTION OF THE DRAWINGS

FIG. 1 shows photographs of a non-thermal plasma reactor used for PFAS treatment experiments.

FIG. 2 shows a graph of normalized PFBS concentration profiles under different treatment conditions.

FIG. 3 shows a graph of fluoride yield as a function of treatment time for various experimental conditions.

### DETAILED DESCRIPTION

The following detailed description provides illustrative embodiments of the disclosed technology, which pertains to systems and methods for treating liquids contaminated per- and polyfluorinated compounds (PFAS) and other toxic organic pollutants. The described technology integrates plasma-based processes with advanced oxidation processes (AOPs) to enhance the degradation and removal of such contaminants. While specific examples, configurations, and operational parameters are described herein, these are provided solely for the purpose of illustration and are not intended to limit the scope of the disclosed technology. The described technology can be applied across a wide range of water treatment scenarios and may be adapted or modified to suit particular applications without departing from the intended scope.

Certain details, such as widely recognized principles of plasma generation, advanced oxidation chemistry, and water treatment system design, may be omitted to promote conciseness and clarity. These omissions are made with the expectation that individuals skilled in the relevant field will readily identify and understand these aspects without requiring detailed explanation.

Additionally, the described subject matter allows for various rearrangements, substitutions, and modifications of the disclosed embodiments, including alternative configurations, materials, and methods, provided they achieve comparable functionality to what is described herein. All such variations are intended to be encompassed within the scope of the subject matter as defined by the appended claims.

The treatment of water contaminated with toxic organic compounds such as per- and polyfluoroalkyl substances (PFAS) presents a significant challenge due to the chemical stability and persistence of these compounds. PFAS, characterized by their strong carbon-fluorine bonds, resist conventional water treatment methods, including adsorption, ion-exchange, and membrane filtration. While advanced oxidation processes (AOPs) such as Fenton's reaction, UV/H₂O₂, and activated persulfate have been employed to degrade organic pollutants, their efficacy against PFAS is limited. These methods often fail to achieve complete mineralization, leaving behind persistent intermediates and fluoride-containing byproducts. Similarly, plasma-based water treatment systems, which generate reactive species at the gas-liquid interface, have demonstrated potential for PFAS degradation but can be hindered by mass-transfer limitations and incomplete defluorination. Existing approaches, whether standalone or integrative, frequently involve high energy consumption, complex operational requirements, and the generation of secondary waste streams, making them impractical for scalable and cost-effective deployment.

The described approach addresses these limitations by integrating non-thermal plasma processes with advanced oxidation processes (AOPs) to enhance the degradation and removal of PFAS and other toxic organic contaminants. This method leverages the complementary strengths of plasma and AOPs to address the limitations of each individual technique. Plasma systems generate a diverse array of reactive species, including atomic oxygen, hydrogen radicals, ozone, and hydrogen peroxide, which are effective at breaking down long-chain PFAS. However, the introduction of AOPs, which produce highly reactive hydroxyl or sulfate radicals, enables the oxidation of intermediate compounds that are otherwise resistant to plasma treatment. This synergistic combination results in more thorough defluorination, as evidenced by higher fluoride yields, and minimizes the accumulation of harmful byproducts.

The described system further incorporates enhancements such as surfactant addition and bubbling to improve the transport of short-chain PFAS to the gas-liquid interface, where plasma reactions occur. Additionally, the system can utilize hydrogen peroxide generated in situ by the plasma process, reducing the need for external chemical inputs. By optimizing the chemical reactions within the reactor and addressing mass-transfer constraints, the disclosed system achieves rapid and efficient degradation of PFAS with reduced energy consumption and operational complexity. This integrated approach represents a notable advancement over conventional water treatment technologies, offering a scalable and environmentally sustainable solution for addressing PFAS contamination.

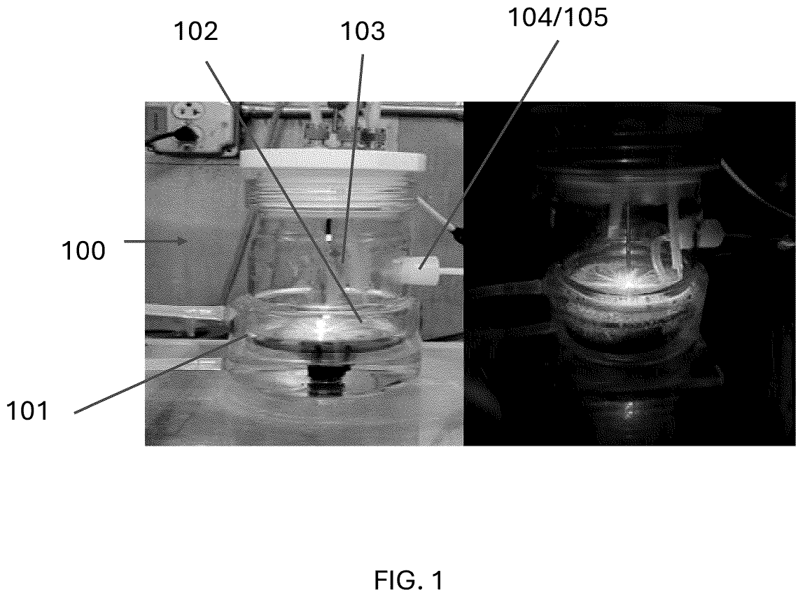

Referring to FIG. 1 is a schematic of a non-thermal plasma reactor 100 utilized for the treatment of liquids contaminated with per- and polyfluorinated compounds PFAS, in accordance with an embodiment. The reactor 100 is configured to generate plasma at the gas-liquid interface 101, thereby facilitating the in situ production of reactive species that contribute to the reductive degradation of PFAS and other toxic organic pollutants. The reactor design emphasizes interface stability and electrical discharge uniformity to ensure reproducible contaminant removal performance.

FIG. 1 shows the operational principle of the non-thermal plasma reactor 100, wherein a high voltage is applied to electrodes 102 positioned within the system to create an electrical discharge plasma. Accordingly, the plasma gives rise to a diverse array of reactive species—atomic oxygen O·, hydrogen radicals H·, ozone O₃, and hydrogen peroxide H₂O₂—each of which is highly effective in cleaving the robust carbon-fluorine bonds characteristic of PFAS compounds. The reactor 100 is further configured to optimize the transport and lifetime of these species in the aqueous phase, thereby ensuring efficient interaction with and degradation of the target pollutants. It should also be noted that external addition of H₂O₂ is possible and could be necessary in certain circumstances where plasma generation of H₂O₂ alone will not always be sufficient.

An enhanced contact design 103 mitigates mass-transfer limitations often encountered in plasma-based water treatment systems. For instance, the reactor 100 may incorporate mechanisms for bubbling 104 or foam fractionation 105, which facilitate the transport of short-chain PFAS to the gas-liquid interface 101 where plasma reactions are more prevalent. As a result, a larger proportion of the PFAS load interacts with high-energy radicals, leading to an improvement in the overall degradation efficiency and fluoride release yield.

In some embodiments, the reactor 100 is designed to incorporate advanced oxidation processes (AOPs) into its operation. The generation of hydrogen peroxide within the reactor via the plasma process can act as a precursor for Fenton's reaction or UV/H₂O₂ treatment, both of which produce hydroxyl radicals ·OH that address intermediate compounds that are resistant to plasma treatment alone. By integrating non-thermal plasma with AOPs, the system enables more comprehensive defluorination and reduces the formation of harmful byproducts. Furthermore, surfactants 106 may be introduced to improve PFAS transport to the reactive zones, particularly for short-chain species. Through these combined chemical and physical enhancements, the reactor 100 supports accelerated and effective PFAS degradation while lowering energy consumption and simplifying operational requirements.

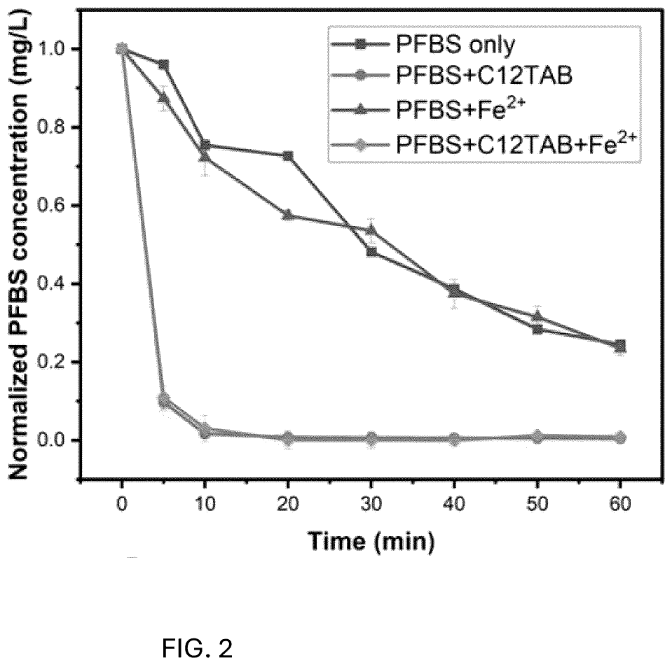

Referring to FIG. 2 are normalized concentration profiles of perfluorobutane sulfonate PFBS over time under four distinct treatment conditions: (i) PFBS only, (ii) PFBS with dodecyltrimethylammonium bromide C12TAB 201, (iii) PFBS with ferrous ions Fe²⁺, and (iv) PFBS with both C12TAB and Fe²⁺. FIG. 2 shows the corresponding degradation efficiencies for each condition, demonstrating the impact of combining surfactant-mediated mass-transfer enhancement and iron-based advanced oxidation processes AOPs with a plasma-based water treatment system. Note that while C12TAB was used in the experiments, the surfactants could be more generally a cationic surfactant or selected from a class of quaternary ammonium surfactants. As C12TAB was used in the experiment demonstrating the invention, that particular surfactant will be referred to herein with the above noted understanding.

Over time, the PFBS-only condition serves as a baseline, illustrating the natural limitations of plasma treatment when used in isolation for short-chain PFAS compounds. Accordingly, the normalized concentration decreases only gradually, which indicates limited degradation efficiency in the absence of any chemical or interfacial enhancements.

By comparison, the introduction of C12TAB significantly accelerates PFBS degradation. The surfactant enhances transport of PFBS molecules to the gas-liquid interface, where plasma-generated reactive species are most active. The enhanced interfacial contact facilitates more efficient reductive attack on PFBS, as evidenced by the steeper concentration decline in FIG. 2. Note, that getting the target compound to the liquid surface is key. So adding a surfactant is necessary for many compounds but not all. Bubbling is just one way to get them there once they combine with the surfactant. Accordingly, foam may be generated by directing a turbulent or laminar liquid jet towards the surface to agitate and churn the liquid or by bubbling gas through a diffuser submerged beneath the liquid surface, after which the gas may be recirculated.

FIG. 2 further illustrates that the addition of Fe²⁺alone, functioning as a catalyst for Fenton's reaction, also enhances PFBS removal. The bulk-phase generation of hydroxyl radicals ·OH works in conjunction with plasma-derived species, leading to increased removal rates of both PFBS and intermediate byproducts formed during the process. These findings indicate that advanced oxidation processes AOPs can provide a solution to the chemical stability of PFAS, which plasma treatment by itself is unable to resolve.

However, the most pronounced reduction in PFBS concentration is observed when both C12TAB and Fe²⁺are applied in combination. In this embodiment, the surfactant's mass-transfer enhancement and the oxidative power of hydroxyl radicals generated through the Fenton reaction operate synergistically. FIG. 2 illustrates rapid and near-complete degradation of PFBS, underscoring the effectiveness of integrating plasma processes with AOPs and surfactant addition.

Accordingly, the data in FIG. 2 underscore the advantages of the disclosed integrated treatment system. By addressing both mass-transfer constraints and the chemical resilience of PFAS compounds, the combined approach achieves superior degradation efficiency compared to standalone plasma or AOP treatments. This strategy demonstrates the potential for scalable, energy-efficient PFAS remediation in contaminated water systems.

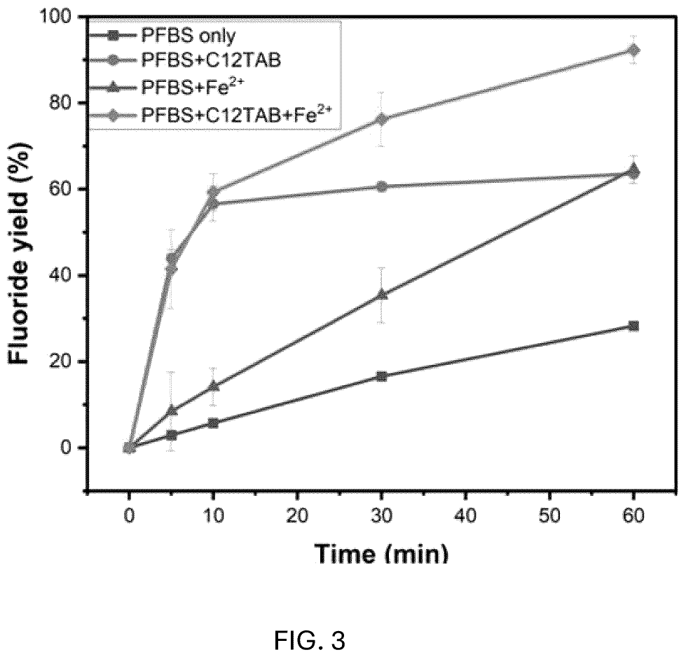

Referring to FIG. 3 are plots of fluoride yield as a function of treatment time under four distinct experimental conditions: (i) perfluorobutane sulfonate PFBS only, (ii) PFBS with dodecyltrimethylammonium bromide C12TAB, (iii) PFBS with ferrous ions Fe²⁺, and (iv) PFBS with both C12TAB and Fe²⁺. The fluoride yield, expressed as a percentage, serves as an indicator of the extent of defluorination achieved during the treatment process.

Referring to FIG. 3, the PFBS-only condition demonstrates the baseline performance of the plasma-based treatment system without any chemical or interfacial enhancements. The fluoride yield increases gradually over time, reflecting the limited ability of plasma treatment alone to achieve complete defluorination—particularly for short-chain PFAS compounds. By comparison, this condition highlights the challenges associated with addressing the chemical stability of PFAS using plasma processes in isolation.

FIG. 3 further illustrates that the addition of C12TAB leads to a notable improvement in fluoride yield compared to the PFBS-only condition. C12TAB, a surfactant, promotes the transport of PFBS molecules to the gas-liquid interface, where plasma-generated reactive species exhibit heightened activity. This enhanced interfacial contact supports more effective cleavage of carbon-fluorine bonds, which contributes to a sharper rise in fluoride yield during the early phases of treatment.

FIG. 3 further demonstrates that the introduction of Fe^{2 +} alone enhances the fluoride yield compared to the baseline condition. Fe²⁺ acts as a catalyst for Fenton's reaction, generating hydroxyl radicals ·OH 305 in the bulk liquid phase. These radicals complement the plasma-derived reactive species, thereby enabling oxidation of intermediate compounds that are resistant to plasma treatment alone. The fluoride yield under this condition increases steadily over time, demonstrating the effectiveness of advanced oxidation processes AOPs in overcoming the chemical resilience of PFAS.

FIG. 3 further depicts the most pronounced improvement in fluoride yield when both C12TAB and Fe²⁺ are applied in combination. This condition leverages the synergistic effects of surfactant-mediated mass-transfer enhancement and the oxidative power of hydroxyl radicals generated through the Fenton reaction. As a result, the fluoride yield increases rapidly during the initial stages of treatment and approaches near-complete defluorination within 60 minutes. These results underscore the effectiveness of integrating plasma processes with AOPs and surfactant addition to achieve comprehensive PFAS degradation.

Overall, FIG. 3 highlights the advantages of the disclosed integrated treatment system in achieving higher fluoride yields compared to standalone plasma or AOP treatments. By addressing both mass-transfer constraints and the chemical stability of PFAS, the combined approach offers a scalable and energy-efficient solution for remediation of PFAS-contaminated water.

The method described achieves a synergistic combination of non-thermal plasma and advanced oxidation processes (AOPs) to enhance the degradation of per-and polyfluorinated compounds (PFAS) in contaminated liquids. By generating non-thermal plasma at the gas-liquid interface, the system produces a diverse array of reactive species, such as atomic oxygen, hydrogen radicals, ozone, and hydrogen peroxide, which are highly effective in breaking the robust carbon-fluorine bonds characteristic of PFAS. This ensures the initial breakdown of long-chain PFAS molecules into shorter-chain intermediates.

The subsequent application of an advanced oxidation process introduces additional oxidative radicals, such as hydroxyl or sulfate radicals, which target and oxidize the intermediate compounds that are resistant to plasma treatment alone. This dual-stage approach addresses the limitations of standalone plasma or AOP treatments, resulting in more thorough defluorination and higher fluoride yields, as evidenced by the complete mineralization of PFAS compounds.

The optional introduction of a surfactant enhances the transport of PFAS molecules, particularly short-chain species, to the gas-liquid interface where plasma reactions are most effective. This mitigates mass-transfer constraints and ensures that a greater proportion of the PFAS load interacts with the reactive species. Additionally, the optional injection of a gas stream facilitates bubble formation and foam fractionation, further improving the contact between PFAS and the reactive zones while enabling the recovery of PFAS-enriched foam from the liquid surface.

This integrated method reduces energy consumption and operational complexity by leveraging in situ production of reactive species and minimizing the need for external chemical inputs. The approach also reduces the generation of harmful byproducts, making the methodology scalable and environmentally sustainable for PFAS remediation in water treatment systems.

The system integrates an electrical discharge plasma reactor with an advanced oxidation process (AOP) unit, a surfactant introduction mechanism, and a gas injection mechanism to treat liquids containing per-and polyfluorinated compounds (PFAS). This arrangement achieves a synergistic combination of physical and chemical processes to enhance the degradation and removal of PFAS.

The electrical discharge plasma reactor generates non-thermal plasma at the gas-liquid interface, producing reactive species such as atomic oxygen, hydrogen radicals, ozone, and hydrogen peroxide. These species are highly effective in breaking the robust carbon-fluorine bonds characteristic of PFAS. By situating the plasma generation at the gas-liquid interface, the system ensures efficient interaction between the reactive species and the PFAS molecules, addressing the mass-transfer limitations commonly encountered in plasma-based water treatment systems.

The advanced oxidation process unit complements the plasma reactor by generating additional oxidative radicals, such as hydroxyl or sulfate radicals, in the bulk liquid. These radicals target intermediate compounds that are resistant to plasma treatment alone, enabling more thorough defluorination and reducing the accumulation of harmful byproducts. This dual-stage approach ensures complete mineralization of PFAS compounds, as evidenced by higher fluoride yields.

The surfactant introduction mechanism further enhances the system's efficiency by promoting the transport of PFAS molecules, particularly short-chain species, to the gas-liquid interface where plasma reactions are most effective. This mitigates the challenges associated with the limited mobility of PFAS in aqueous solutions, ensuring that a greater proportion of the contaminant load interacts with the reactive species.

The gas injection mechanism facilitates bubble formation and foam fractionation, which improve the contact between PFAS and the reactive zones. Additionally, foam fractionation enables the transport of PFAS-enriched foam to the liquid surface, reducing the concentration of contaminants in the treated liquid and minimizing secondary waste generation.

Overall, the system described provides a scalable and energy-efficient solution for PFAS remediation by integrating complementary processes that address both the chemical stability of PFAS and the operational challenges of existing treatment technologies. This integration reduces energy consumption, simplifies operational requirements, and minimizes the need for external chemical inputs, making the system suitable for large-scale water treatment applications.

What is claimed is:

1. A method for treating a liquid containing toxic organic compounds, comprising:
contacting the liquid with non-thermal plasma generated at a gas-liquid interface in an enhanced-contact electrical discharge plasma reactor;
producing reactive species in situ within the liquid;
further treating the liquid with an advanced oxidation process (AOP) to generate additional oxidative radicals;
introducing a surfactant to the liquid to promote transport of toxic organic compounds to the gas-liquid interface; and
injecting a gas stream to facilitate bubble formation and foam fractionation in the liquid.

2. The method of claim 1, wherein said advanced oxidation process comprises Fenton's reaction.

3. The method of claim 1, wherein said advanced oxidation process comprises UV/H₂O₂ treatment.

4. The method of claim 1, wherein said advanced oxidation process comprises activated persulfate oxidation.

5. The method of claim 1, wherein said advanced oxidation process comprises UV irradiation in the presence of titanium dioxide.

6. The method of claim 1, wherein hydrogen peroxide for said advanced oxidation process is produced in situ by said non-thermal plasma.

7. The method of claim 1, wherein said surfactant is selected from any cationic surfactants.

8. The method of claim 7, wherein said surfactant is selected from a class of quaternary ammonium surfactants.

9. The method of claim 8, wherein said surfactant is dodecyltrimethylammonium bromide.

10. The method of claim 1, wherein said gas stream comprises argon.

11. The method of claim 1, wherein said non-thermal plasma is generated by applying a pulsed voltage of between −20 kV and −40 kV to said electrodes.

12. The method of claim 1, wherein said reactive species produced in situ include atomic oxygen, hydrogen radicals, ozone, and hydrogen peroxide.

13. The method of claim 1, wherein said foam fractionation is employed to transport toxic organic compounds enriched foam to said liquid surface.

14. The method of claim 1, wherein said liquid comprises an aqueous solution.

15. A system for treating a liquid containing toxic organic compounds, comprising:
an electrical discharge plasma reactor configured to generate non-thermal plasma at a gas-liquid interface and produce reactive species within the liquid;
an advanced oxidation process unit operatively associated with the plasma reactor and configured to generate additional oxidative radicals in the liquid;
a surfactant introduction mechanism configured to introduce a surfactant into the liquid to promote transport of toxic organic compounds to the gas-liquid interface; and
a gas injection mechanism configured to supply a gas stream to facilitate bubble formation and foam fractionation in the liquid.

16. The system of claim 15, wherein said advanced oxidation process unit comprises a Fenton's reaction unit comprising heterogeneous Fenton and photo-Fenton.

17. The system of claim 15, wherein said advanced oxidation process unit comprises a UV/H₂O₂ treatment unit.

18. The system of claim 15, wherein said advanced oxidation process unit comprises an activated persulfate oxidation unit.

19. The system of claim 15, wherein said advanced oxidation process unit comprises a UV irradiation unit in the presence of titanium dioxide.

20. The system of claim 15, wherein said electrical discharge plasma reactor is configured to produce hydrogen peroxide in situ for use by said advanced oxidation process unit.

21. The system of claim 15, wherein said surfactant introduction mechanism is configured to introduce any cationic surfactants into the liquid.

22. The method of claim 21, wherein said surfactant introduction mechanism is configured to introduce any selected from a class of quaternary ammonium surfactants into the liquid.

23. The system of claim 22, wherein said surfactant introduction mechanism is configured to introduce dodecyltrimethylammonium bromide into the liquid.

24. The system of claim 15, wherein said gas injection mechanism is configured to supply an argon gas stream to the liquid.

25. The system of claim 15, wherein said gas injection mechanism further facilitates foam fractionation to recover toxic organic compounds enriched foam from the liquid surface.

26. The system of claim 15, wherein said electrical discharge plasma reactor is configured to apply a pulsed voltage of between −20 kV and −40 kV to the electrodes.

27. The system of claim 15, wherein reactive species produced by said electrical discharge plasma reactor comprise atomic oxygen, hydrogen radicals, ozone, and hydrogen peroxide.

28. The system of claim 15, wherein the liquid comprises an aqueous solution.
